(19) United States
(12) Patent Application Publication
(10) Pub. No.: US 2021/0291551 A1
(43) Pub. Date: Sep. 23, 2021

(54) MANUFACTURING METHOD OF PRINTED ARTICLE AND PRINTING DEVICE

(71) Applicant: FUJIFILM Corporation, Tokyo (JP)

(72) Inventor: Hiroshi MATAKI, Kanagawa (JP)

(73) Assignee: FUJIFILM Corporation, Tokyo (JP)

(21) Appl. No.: 17/340,101

(22) Filed: Jun. 7, 2021

Related U.S. Application Data
(63) Continuation of application No. PCT/JP2019/046365, filed on Nov. 27, 2019.

(30) Foreign Application Priority Data
Dec. 26, 2018 (JP) 2018-242817

(51) Int. Cl. B41J 2/21

(52) U.S. Cl. CPC B41J 2/2117; B41J 2/2132

(57) ABSTRACT

Provided are a manufacturing method of a printed article and a printing device which obtain a back printed article with a high image quality. A first treatment liquid which contains an aggregating agent that aggregates a color ink and a white ink is added to an impermeable medium, the color ink is applied to the impermeable medium to which the first treatment liquid is added to print an image, and the white ink is applied to the impermeable medium to which the color ink is applied. In a case in which a total amount of an applied amount of the color ink and an applied amount of the white ink exceeds a threshold value, a second treatment liquid which contains at least the aggregating agent that aggregates the white ink is added to the impermeable medium after the color ink is applied and before the white ink is applied.

### CROSS-REFERENCE TO RELATED APPLICATIONS

The present application is a Continuation of PCT International Application No. PCT/JP2019/046365 filed on Nov. 27, 2019 claiming priority under 35 U.S.C § 119(a) to Japanese Patent Application No. 2018-242817 filed on Dec. 26, 2018. Each of the above applications is hereby expressly incorporated by reference, in its entirety, into the present application.

### BACKGROUND OF THE INVENTION

### 1. Field of the Invention

The present invention relates to a manufacturing method of a printed article and a printing device, in particular, to a technique of manufacturing a back printed article.

### 2. Description of the Related Art

A so-called back printed article is known in which an image printed on a transparent medium is visually recognized through the medium from a surface opposite to the surface to which the ink is applied to the medium. JP2011-161756A discloses an ink jet printer that prints the image by applying a color ink, and then prints a background by applying a white ink in a case of performing back printing of a color image on a transparent film.

Further, a method of printing by aggregating an ink with a treatment liquid is known. JP2001-353861A discloses an ink jet recording device in which a treatment liquid containing a color material aggregating agent is applied to a recording medium, and each color ink is jetted to the recording medium to which the treatment liquid is applied by an ink jet head to record an image.

### SUMMARY OF THE INVENTION

In a case in which the color ink is applied after the treatment liquid that aggregates the ink is added, the white ink is further applied, and the back printing of the flexible packaging is performed, in a case in which the total ink amount of the color ink and the white ink is large, the aggregating property of the treatment liquid may be insufficient. In a case in which the aggregating property of the treatment liquid is insufficient, there is a problem that bleed-through occurs in the printed article.

In order to prevent this, it is conceivable to increase the amount of the treatment liquid which is added before the color ink is applied. However, in a case in which the amount of the treatment liquid is too large, the dot diameter of the color ink becomes small, and there is a problem that desired image quality and density cannot be obtained.

The present invention has been made in view of such circumstances, and an object of the present invention is to provide a manufacturing method of a printed article and a printing device which obtain a back printed article with a high image quality.

In order to achieve the above object, an aspect of a manufacturing method of a printed article is a manufacturing method of a printed article, the method comprising a first treatment liquid adding step of adding a first treatment liquid which contains an aggregating agent that aggregates a color ink and a white ink to a transparent impermeable medium which is a printed article, a color ink applying step of applying the color ink to the impermeable medium to which the first treatment liquid is added by an ink jet method to print an image, a white ink applying step of applying the white ink to the impermeable medium to which the color ink is applied by the ink jet method, a calculating step of calculating a total amount of an applied amount of the color ink and an applied amount of the white ink, and a second treatment liquid adding step of, in a case in which the total amount exceeds a threshold value, adding a second treatment liquid which contains at least the aggregating agent that aggregates the white ink to the impermeable medium by the ink jet method after the color ink is applied and before the white ink is applied.

According to the aspect, in a case in which a total amount of an applied amount of the color ink and an applied amount of the white ink exceeds a threshold value, a second treatment liquid which contains at least the aggregating agent that aggregates the white ink is added to the impermeable medium by an ink jet method after the color ink is applied and before the white ink is applied, and thus it is possible to obtain a back printed article with a high image quality.

It is preferable that the manufacturing method further comprise an image acquiring step of acquiring image data indicating the image, in which in the calculating step, the total amount is calculated from the image data. As a result, the total amount can be calculated appropriately.

It is preferable that the manufacturing method further comprise a dividing step of dividing the image into a plurality of regions, in which in the calculating step, the total amount is calculated for each of the divided regions, and in the second treatment liquid adding step, the second treatment liquid is added to a print region of the impermeable medium, which corresponds to the region in which the total amount exceeds the threshold value. As a result, the second treatment liquid can be appropriately added depending on the total amount applied to the print region of the impermeable medium.

It is preferable that the manufacturing method further comprise a first drying step of drying the impermeable medium to which the color ink is applied. As a result, the color ink can be dried appropriately.

It is preferable that the manufacturing method further comprise a second drying step of drying the impermeable medium to which the white ink is applied. As a result, the white ink can be dried appropriately.

It is preferable that in the first treatment liquid adding step, the first treatment liquid be applied to the impermeable medium by using a coating roller. As a result, the first treatment liquid can be added appropriately.

It is preferable that the first treatment liquid and the second treatment liquid contain an acid. As a result, the color ink and the white ink can be aggregated appropriately.

It is preferable that an amount of the acid per unit area of the first treatment liquid which is added to the impermeable medium be equal to an amount of the acid per unit area of the second treatment liquid which is added to the impermeable medium. As a result, the color ink and the white ink can be aggregated appropriately.

In order to achieve the above object, an aspect of a printing device is a printing device comprising a first treatment liquid adding unit that adds a first treatment liquid which contains an aggregating agent that aggregates a color ink and a white ink to an impermeable medium, a color ink applying unit that applies the color ink to the impermeable medium to which the first treatment liquid is added by an ink jet method to print an image, a white ink applying unit that applies the white ink to the impermeable medium to which the color ink is applied by the ink jet method, a calculating unit that calculates a total amount which is a sum of an applied amount of the color ink and an applied amount of the white ink, and a second treatment liquid adding unit that adds, in a case in which the total amount exceeds a threshold value, a second treatment liquid which contains at least the aggregating agent that aggregates the white ink to the impermeable medium by the ink jet method after the color ink is applied and before the white ink is applied.

According to the aspect, in a case in which a total amount of an applied amount of the color ink and an applied amount of the white ink exceeds a threshold value, a second treatment liquid which contains at least the aggregating agent that aggregates the white ink is added to the impermeable medium by an ink jet method after the color ink is applied and before the white ink is applied, and thus it is possible to obtain a back printed article with a high image quality.

It is preferable that the printing device further comprise a transporting unit that transports the impermeable medium to the first treatment liquid adding unit, the color ink applying unit, the second treatment liquid adding unit, and the white ink applying unit in this order. As a result, it is possible to perform printing on the impermeable medium appropriately.

It is preferable that the transporting unit draw out a long impermeable medium which is wound in a roll shape to transport the impermeable medium, and wind the printed impermeable medium in the roll shape. As a result, it is possible to perform printing on the impermeable medium such as flexible packaging, appropriately.

According to the present invention, it is possible to obtain a back printed article with a high image quality.

### BRIEF DESCRIPTION OF THE DRAWINGS

FIG. 1 is a schematic diagram showing an outline of an ink jet recording device.

FIG. 2 is a block diagram showing an electric configuration of the ink jet recording device.

FIG. 3 is a flowchart showing a process of a manufacturing method of a printed article according to a first embodiment.

FIG. 4 is a flowchart showing a process of a manufacturing method of a printed article according to a second embodiment.

### DESCRIPTION OF THE PREFERRED EMBODIMENTS

Preferred embodiments of the present invention will be described below in detail with reference to the accompanying drawings. In the present specification, in a case in which the numerical range is represented by using “to”, the numerical range includes numerical values of the upper limit and lower limit indicated by “to”.

<Configuration of Ink Jet Recording Device>

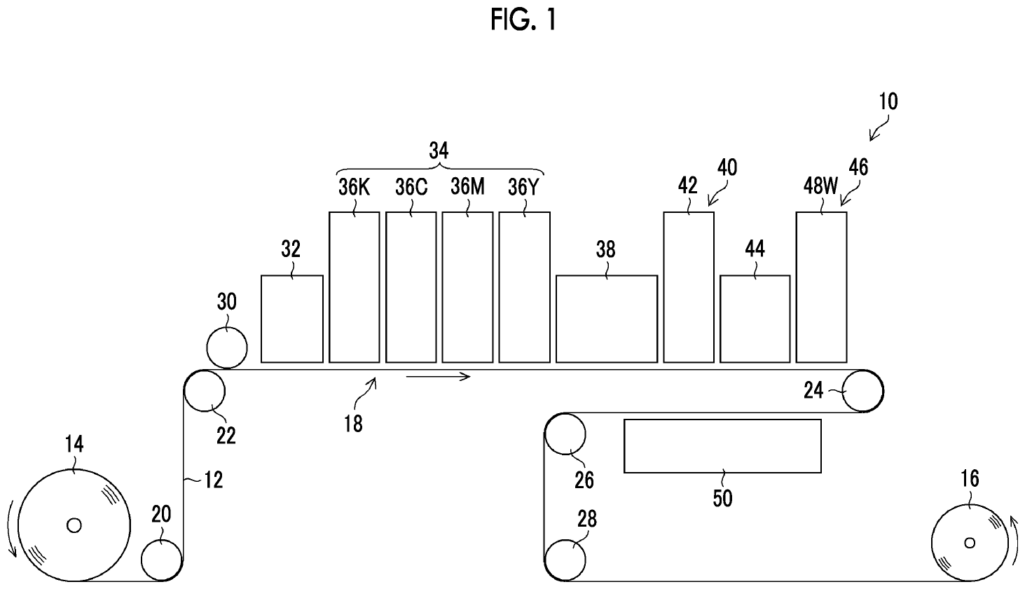

FIG. 1 is a schematic diagram showing an outline of an ink jet recording device 10 according to the present embodiment. The ink jet recording device 10 is a printing device that prints an image on a long impermeable medium 12 by a single pass method. The impermeable medium 12 according to the present embodiment is a transparent medium used for flexible packaging. The ink jet recording device 10 can manufacture a back printed article in which a print target is visually recognized from the surface opposite to the printed surface with respect to the impermeable medium 12.

Impermeable means having impermeability with respect to a treatment liquid and an ink, which are described below. Flexible packaging means packaging made of a material that is deformed depending on the shape of the article to be packaged. Transparency means that the light transmittance of visible light is 30% or more, and is preferably 70% or more.

As shown in FIG. 1, the ink jet recording device 10 comprises a sending roll 14, a winding roll 16, a transporting unit 18, a first treatment liquid adding unit 30, a first treatment liquid drying unit 32, a color ink applying unit 34, a color ink drying unit 38, a second treatment liquid adding unit 40, a second treatment liquid drying unit 44, a white ink applying unit 46, and a white ink drying unit 50.

The sending roll 14 comprises a reel which is rotatably supported (not shown). The impermeable medium 12 before the image is printed is wound on the reel in a roll shape.

The winding roll 16 comprises a reel which is rotatably supported (not shown). One end of the impermeable medium 12 is connected to the reel.

The transporting unit 18 comprises guide rollers 20, 22, 24, 26, and 28. Further, the transporting unit 18 comprises a sending motor (not shown) that rotationally drives the reel of the sending roll 14, and a winding motor (not shown) that rotationally drives the reel of the winding roll 16.

The transporting unit 18 rotationally drives the reel of the sending roll 14 by the sending motor, and sends out the impermeable medium 12 from the sending roll 14. Further, the transporting unit 18 rotationally drives the reel of the winding roll 16 by the winding motor and winds the printed impermeable medium 12 by the winding roll 16.

The transporting unit 18 guides the impermeable medium 12, which is sent out from the sending roll 14, by the guide rollers 20, 22, 24, 26, and 28, and transports the impermeable medium 12 to the first treatment liquid adding unit 30, the first treatment liquid drying unit 32, the color ink applying unit 34, the color ink drying unit 38, the second treatment liquid adding unit 40, the second treatment liquid drying unit 44, the white ink applying unit 46, and the white ink drying unit 50, in this order. In this way, the impermeable medium 12 is transported in a roll-to-roll manner by a transport route from the sending roll 14 to the winding roll 16 being guided by the guide rollers 20, 22, 24, 26, and 28.

The guide rollers 20 and 22 are disposed on the downstream side of the sending roll 14 in the transport route of the impermeable medium 12. The impermeable medium 12 which is sent out from the sending roll 14 is guided by the guide rollers 20 and 22 and transported to the first treatment liquid adding unit 30.

The first treatment liquid adding unit 30 adds a first treatment liquid to a printed surface of the impermeable medium 12. The first treatment liquid contains an aggregating agent which has an action of aggregating the components contained in a color ink and a white ink. Examples of the aggregating agent contain an acidic compound, a polyvalent metal salt, a cationic polymer, and the like. The first treatment liquid according to the present embodiment is an acidic liquid which contains an acid as the aggregating agent.

The first treatment liquid adding unit 30 uniformly applies the first treatment liquid to the printed surface of the impermeable medium 12 by using a coating roller (not shown). An application amount of the first treatment liquid need only be an amount that appropriately aggregates the color ink which is applied by the color ink applying unit 34. The first treatment liquid adding unit 30 may uniformly add the first treatment liquid by using a head which jets the first treatment liquid by an ink jet method.

The impermeable medium 12 may be heated before the first treatment liquid is added. The heating temperature need only be appropriately set depending on the type of the impermeable medium 12 and the composition of the first treatment liquid, but the temperature of the impermeable medium 12 is preferably 20° C. to 50° C., and more preferably 25° C. to 40° C.

The first treatment liquid drying unit 32 is disposed on the downstream side of the first treatment liquid adding unit 30 in the transport route of the impermeable medium 12. The first treatment liquid drying unit 32 dries the first treatment liquid which is added to the printed surface of the impermeable medium 12.

The first treatment liquid drying unit 32 can be configured by using known heating means such as a heater, blowing means using blowing air such as a dryer, or means combining these. As the heating means, there is a method of disposing a heat generating body such as a heater on the opposite side to the printed surface of the impermeable medium 12, a method of applying warm air or hot air to the printed surface of the impermeable medium 12, or a heating method using an infrared heater, and heating may be performed by combining a plurality of these methods.

Further, the temperature of the printed surface of the impermeable medium 12 changes depending on the type (material, thickness, and the like) of the impermeable medium 12, the environmental temperature, and the like. Therefore, it is preferable that a measuring unit that measures the temperature of the printed surface of the impermeable medium 12 and a control mechanism that feeds back the temperature value measured by the measuring unit to the first treatment liquid drying unit 32 be provided, and the first treatment liquid be dried while controlling the temperature. A contact or non-contact thermometer is preferable as the measuring unit that measures the temperature of the printed surface of the impermeable medium 12.

Also, a solvent may be removed by using a solvent removing roller or the like. As another embodiment, a method of removing excess solvent from the impermeable medium 12 by using an air knife is also used.

The color ink applying unit 34 is disposed on the downstream side of the first treatment liquid drying unit 32 in the transport route of the impermeable medium 12. The color ink applying unit 34 applies the color ink to the printed surface of the impermeable medium 12 to which the first treatment liquid is added by an ink jet method to print the image. The color ink is an ink, which contains a coloring agent. The ink is also referred to as an ink composition. Here, four color inks of a black ink, a cyan ink, a magenta ink, and a yellow ink are applied.

The color ink applying unit 34 comprises ink jet heads 36K, 36C, 36M, and 36Y. The ink jet heads 36K, 36C, 36M, and 36Y are arranged at regular intervals along the transport route of the impermeable medium 12. The ink jet heads 36K, 36C, 36M, and 36Y are line heads which can record images on the impermeable medium 12 by a single pass. The line head is a head in which a plurality of nozzles (not shown) that jet liquid droplets are arranged over a length equal to or more than the width in the direction orthogonal to the traveling direction of the impermeable medium 12. The line head may be configured by connecting a plurality of head modules (not shown) together.

The ink jet heads 36K, 36C, 36M, and 36Y jet the liquid droplets of aqueous black ink, cyan ink, magenta ink, and yellow ink, which contain the coloring agents of black, cyan, magenta, and yellow, respectively, to print a color image on the printed surface of the impermeable medium 12. The color ink jetted on the printed surface of the impermeable medium 12 is aggregated by the first treatment liquid which is added to the printed surface in advance.

The color ink applying unit 34 may print the color image by a shuttle method of jetting the ink while scanning a short serial head in the width direction of the impermeable medium 12.

The color ink drying unit 38 is disposed on the downstream side of the color ink applying unit 34 in the transport route of the impermeable medium 12. The color ink drying unit 38 heats the impermeable medium 12 on which the image is printed, and dries the color ink. The color ink drying unit 38 can have the same configuration as the first treatment liquid drying unit 32.

The second treatment liquid adding unit 40 is disposed on the downstream side of the color ink drying unit 38 in the transport route of the impermeable medium 12. The second treatment liquid adding unit 40 adds the second treatment liquid to the printed surface of the impermeable medium 12 by the ink jet method after the color ink is applied and before the white ink is applied.

The second treatment liquid contains at least the aggregating agent which has an action of aggregating the components contained in the white ink. Examples of the aggregating agent contain an acidic compound, a polyvalent metal salt, a cationic polymer, and the like. The second treatment liquid according to the present embodiment is an acidic liquid which has a viscosity different from that of the first treatment liquid. Therefore, the second treatment liquid has the action of aggregating the components contained in the color ink and the white ink. In addition, the second treatment liquid has a viscosity suitable for jetting by the ink jet method.

The second treatment liquid adding unit 40 comprises a second treatment liquid jetting head 42 which jets the second treatment liquid by the ink jet method. The second treatment liquid jetting head 42 is a line head which can add the second treatment liquid to the impermeable medium 12 by the single pass. The second treatment liquid adding unit 40 jets the second treatment liquid from the second treatment liquid jetting head 42 and adds the second treatment liquid to the printed surface of the impermeable medium 12. The second treatment liquid adding unit 40 may add the second treatment liquid by the shuttle method using the short serial head. An added amount of the second treatment liquid need only be, for example, an amount that appropriately aggregates the white ink which is applied by the white ink applying unit 46.

In a case in which the second treatment liquid is added by a contact method after the color ink is applied, the color ink may be transferred to the contact portion. The second treatment liquid adding unit 40 jets the second treatment liquid by the ink jet method, transfer to the contact portion does not occur, and the second treatment liquid can be added appropriately.

The second treatment liquid drying unit 44 is disposed on the downstream side of the second treatment liquid adding unit 40 in the transport route of the impermeable medium 12. The second treatment liquid drying unit 44 dries the second treatment liquid which is added to the printed surface of the impermeable medium 12. The second treatment liquid drying unit 44 can have the same configuration as the first treatment liquid drying unit 32.

The white ink applying unit 46 is disposed on the downstream side of the second treatment liquid drying unit 44 in the transport route of the impermeable medium 12. The white ink applying unit 46 applies the white ink to the impermeable medium 12 to which the color ink is applied by the ink jet method. The white ink is not limited to a pure white ink, and examples thereof include a light-colored ink that can be used as a background ink for back printing of the transparent impermeable medium 12.

A ink jet head 48W is a line head which can apply an aqueous white ink, which contains a white coloring agent, to the impermeable medium 12 by the single pass. The ink jet head 48W jets the liquid droplets of white ink to apply the white ink to the printed surface of the impermeable medium 12. The white ink applying unit 46 may apply the white ink by the shuttle method using the short serial head. The white ink applied on the printed surface of the impermeable medium 12 is aggregated by the first treatment liquid and the second treatment liquid which are added to the printed surface in advance.

The guide roller 24 is disposed on the downstream side of the white ink applying unit 46 in the transport route of the impermeable medium 12, and the traveling direction of the impermeable medium 12 is folded back. The white ink drying unit 50 is disposed on the downstream side of the guide roller 24 in the transport route of the impermeable medium 12.

The white ink drying unit 50 heats the impermeable medium 12 to which the white ink is applied, and finally dries the impermeable medium 12. The white ink drying unit 50 can have the same configuration as the first treatment liquid drying unit 32.

The ink jet recording device 10 is designed to save a space by folding back the traveling direction of the impermeable medium 12 by the guide roller 24, but may transport the impermeable medium 12 in a fixed direction from the sending roll 14 to the winding roll 16.

The guide rollers 26 and 28 are disposed on the downstream side of the white ink drying unit 50 in the transport route of the impermeable medium 12.

The impermeable medium 12 is guided to the winding roll 16 by the guide rollers 26 and 28. The winding roll 16 winds the impermeable medium 12, which is a back printed article, on the reel.

<Electric Configuration of Ink Jet Recording Device>

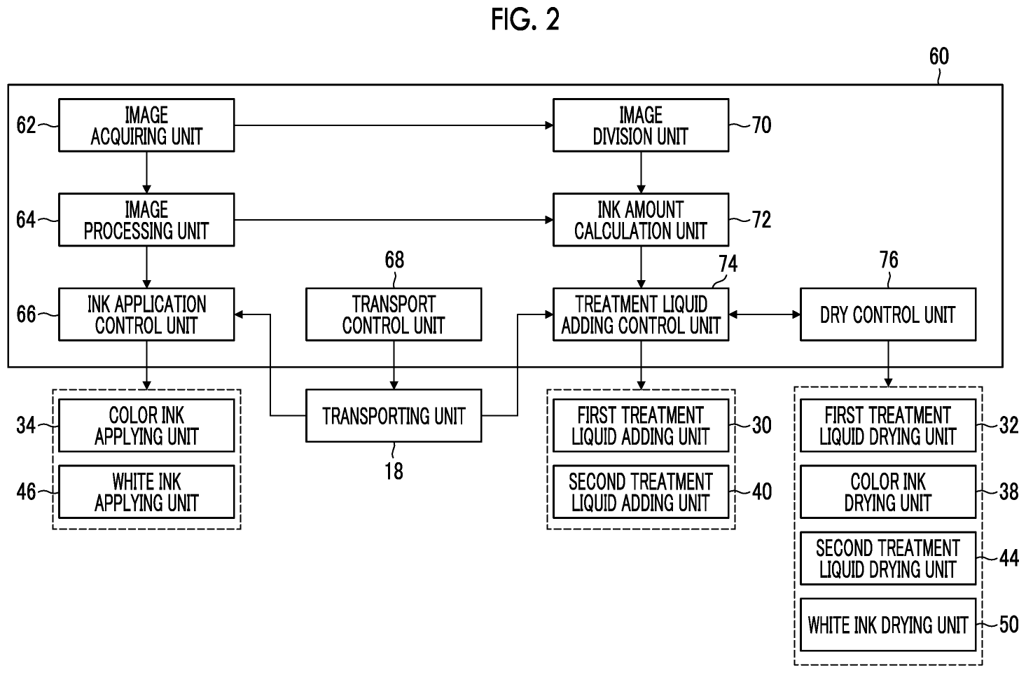

FIG. 2 is a block diagram showing an electric configuration of the ink jet recording device 10. As shown in FIG. 2, the ink jet recording device 10 comprises a control unit 60 that controls the ink jet recording device 10 in an integrated manner. The control unit 60 comprises an image acquiring unit 62, an image processing unit 64, an ink application control unit 66, a transport control unit 68, an image division unit 70, an ink amount calculation unit 72, a treatment liquid adding control unit 74, and a dry control unit 76.

The image acquiring unit 62 acquires image data indicating the image to be printed by the ink jet recording device 10 from an input unit (not shown).

The image processing unit 64 performs plate separation processing, halftone processing, or the like on the acquired image data to generate dot data. The plate separation processing converts the color system of each pixel of the image data into a gradation value for each of black, cyan, magenta, yellow, and white. The halftone processing generates binarized dot data which defines the presence or absence of dots for each pixel from the gradation value for each color of the image data.

The image processing unit 64 may generate background image data based on the image data, and may generate the binarized dot data which defines the presence or absence of white dots for each pixel. Further, the image processing unit 64 may generate background image data of a so-called solid image in which dots of white ink are disposed on the entire surface of the printed surface.

The ink application control unit 66 controls the ink jet heads 36K, 36C, 36M, and 36Y. The ink application control unit 66 jets the liquid droplets based on the dot data for each color from the ink jet heads 36K, 36C, 36M, and 36Y in synchronization with the transport of the impermeable medium 12 by the transporting unit 18, and prints the color image on the printed surface of the impermeable medium 12. Further, the ink application control unit 66 jets the liquid droplets based on the white dot data for each color from the ink jet heads 48W in synchronization with the transport of the impermeable medium 12 by the transporting unit 18, and prints the background image on the printed surface of the impermeable medium 12.

The transport control unit 68 controls the transporting unit 18. The transport control unit 68 rotationally drives the sending motor and the winding motor (which are not shown) of the transporting unit 18 to transport the impermeable medium 12. Further, the transporting unit 18 comprises an encoder (not shown). The transporting unit 18 outputs encoder signals output from the encoder to the ink application control unit 66 and the treatment liquid adding control unit 74.

The image division unit 70 divides the image indicated by the image data into a plurality of regions. The image division unit 70 divides the image into, for example, rectangular regions with m regions vertically and n regions horizontally, in total of m×n. Both m and n are natural numbers, and at least one of m or n is a natural number of 2 or more. The image division unit 70 may divide the image depending on the contour included in the image, the brightness distribution, or the like. A smallest unit of division is a pixel.

The ink amount calculation unit 72 calculates the total ink amount (an example of the total amount) which is the sum of the applied amount of the color ink and the applied amount of the white ink based on the result of the plate separation processing by the image processing unit 64. The ink amount calculation unit 72 may calculate the total ink amount for each of the regions divided by the image division unit 70.

The treatment liquid adding control unit 74 controls the first treatment liquid adding unit 30 and the second treatment liquid adding unit 40. The treatment liquid adding control unit 74 controls the second treatment liquid jetting head 42, and controls whether or not the second treatment liquid is added to the printed surface of the impermeable medium 12. The treatment liquid adding control unit 74 may selectively add the second treatment liquid to the print region of the impermeable medium 12, which corresponds to the region divided by the image division unit 70 on the printed surface of the impermeable medium 12. Details of the adding of the second treatment liquid will be described below.

The dry control unit 76 controls the first treatment liquid drying unit 32, the color ink drying unit 38, the second treatment liquid drying unit 44, and the white ink drying unit 50.

<Manufacturing Method of Printed Article: First Embodiment>

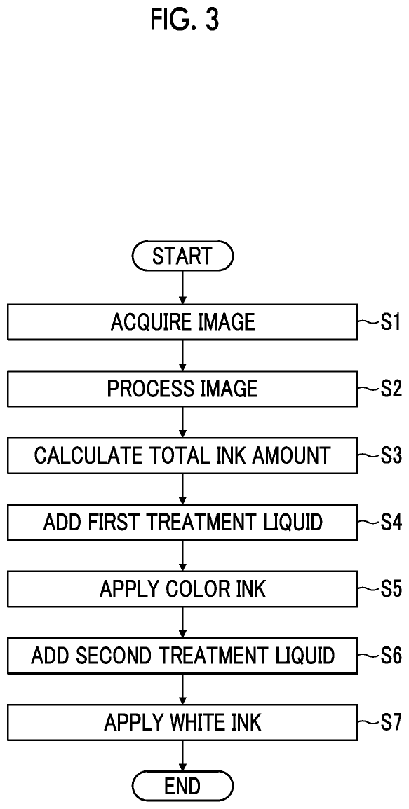

FIG. 3 is a flowchart showing a process of a manufacturing method of a printed article by using the ink jet recording device 10. Here, back printing is performed on the impermeable medium 12 to manufacture the printed article.

As shown in FIG. 3, the manufacturing method of the printed article comprises an image acquiring step (step S1), a calculating step (step S3), a first treatment liquid adding step (step S4), a color ink applying step (step S5), a white ink applying step (step S7), and a second treatment liquid adding step (step S6).

In step S1, the image acquiring unit 62 acquires image data indicating the image to be printed by the ink jet recording device 10.

In step S2, the image processing unit 64 performs the plate separation processing, the halftone processing, or the like on the acquired image data to generate black, cyan, magenta, yellow, and white dot data.

In step S3, the ink amount calculation unit 72 calculates the total ink amount which is the sum of the applied amount of the color ink and the applied amount of the white ink based on the result of the plate separation processing by the image processing unit 64.

In step S4, the treatment liquid adding control unit 74 adds the first treatment liquid to the printed surface of the impermeable medium 12 by the first treatment liquid adding unit 30. The added amount of the first treatment liquid is not particularly limited as long as the color ink can be aggregated, but in the present embodiment, it is 1.5 g/m². The dry control unit 76 dries the first treatment liquid, which is added to the printed surface of the impermeable medium 12, by the first treatment liquid drying unit 32.

In step S5, the ink application control unit 66 prints the color image based on the image data on the printed surface of the impermeable medium 12 by the ink jet heads 36K, 36C, 36M, and 36Y. Further, the dry control unit 76 dries the color ink applied to the printed surface of the impermeable medium 12 by the color ink drying unit 38 (an example of the first drying step).

In step S6, in a case in which the total ink amount calculated by the ink amount calculation unit 72 in step S3 exceeds the threshold value, the treatment liquid adding control unit 74 adds the second treatment liquid to the printed surface of the impermeable medium 12 by the second treatment liquid adding unit 40. Further, in a case in which the total ink amount does not exceed the threshold value, the treatment liquid adding control unit 74 does not add the second treatment liquid. The threshold value may be stored in a memory (not shown) in advance, or may be acquired from the input unit (not shown).

The added amount of the second treatment liquid is 2.6 g/m² in the present embodiment. Although the amount of the first treatment liquid added by the first treatment liquid adding unit 30 and the amount of the second treatment liquid added by the second treatment liquid adding unit 40 are different, the added amounts of the acids thereof are equal to each other. That is, the amount of the acid per unit area of the first treatment liquid which is added to the impermeable medium 12 is equal to an amount of the acid per unit area of the second treatment liquid.

In a case in which the second treatment liquid is added, the dry control unit 76 dries the second treatment liquid on printed surface of the impermeable medium 12 by the second treatment liquid drying unit 44. In a case in which the second treatment liquid is not added, the dry control unit 76 stops the second treatment liquid drying unit 44.

In step S7, the ink application control unit 66 applies the white ink to the printed surface of the impermeable medium 12 by the ink jet head 48W. Further, the dry control unit 76 dries the white ink on the printed surface of the impermeable medium 12 by the white ink drying unit 50 (an example of the second drying step).

The heating temperature of the white ink drying unit 50 is preferably 60° C. or higher, more preferably 65° C. or higher, and particularly preferably 70° C. or higher. The upper limit of the heating temperature is not particularly limited, but the upper limit is, for example, 100° C., and is preferably 90° C. The heating time is not particularly limited, but it is preferably 3 seconds to 60 seconds, more preferably 5 seconds to 30 seconds, and particularly preferably 5 seconds to 20 seconds.

As described above, the ink jet recording device 10 can use the impermeable medium 12 as a back printed article.

According to the present embodiment, the color ink can be aggregated by the first treatment liquid which is added before the color ink is applied, and the color image with a high image quality can be printed. In a case in which the total ink amount exceeds the threshold value, the second treatment liquid is added to the impermeable medium 12 after the color ink is applied and before the white ink is applied, so that the white ink can be appropriately aggregated even in a case in which the total ink amount exceeds the threshold value. Therefore, it is possible to obtain a back printed article with a high image quality.

In the present embodiment, the color ink is dried by the color ink drying unit 38 after the color ink is applied to the printed surface of the impermeable medium 12, but dry of the color ink is not essential. Normally, the reason why the color ink is dried is that in a case in which the white ink is applied without drying the color ink, the color ink applied to the printed surface in advance bleeds by the white ink. However, in the present embodiment, by adding the second treatment liquid after applying the color ink, the color ink applied to the printed surface is aggregated by the second treatment liquid. Therefore, even in a case in which the white ink is applied without drying the color ink, the color ink does not bleed. Therefore, the color ink drying unit 38 can be omitted.

<Manufacturing Method of Printed Article: Second Embodiment>

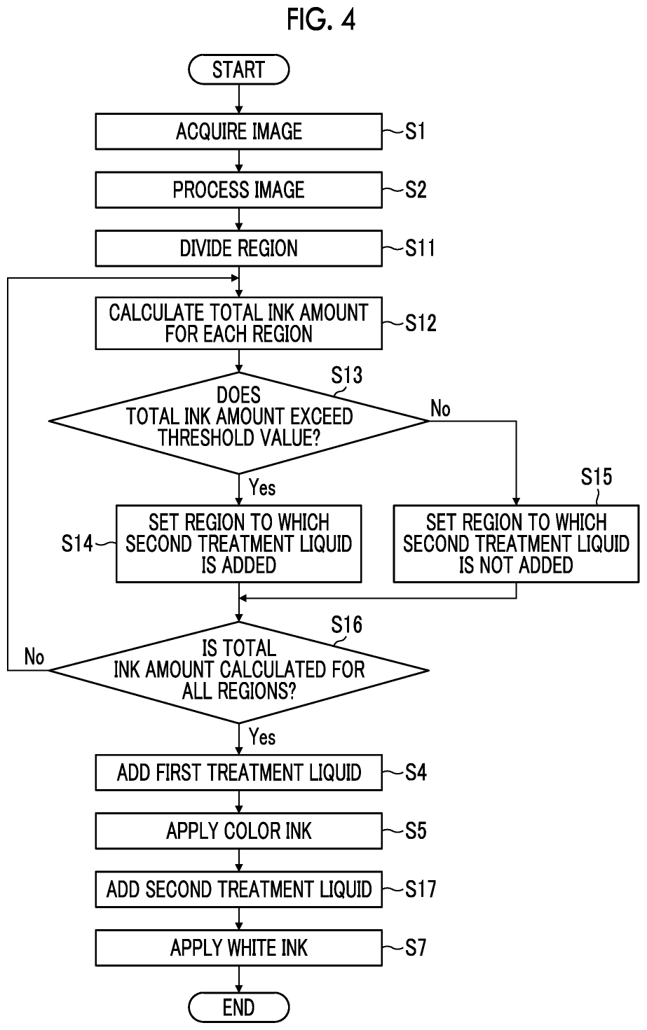

The ink jet recording device 10 according to a second embodiment adds the second treatment liquid only to a region of the printed surface of the impermeable medium 12 in which determination is made that the second treatment liquid is necessary. FIG. 4 is a flowchart showing a process of a manufacturing method of a printed article according to the second embodiment. In the same manner as in the first embodiment, an example will be described in which back printing is performed on the impermeable medium 12 to manufacture the printed article. The parts common to those of the flowchart shown in FIG. 3 are designated by the same reference numerals, and detailed description thereof will be omitted.

In step S1, the image acquiring unit 62 acquires the image data indicating the image to be printed by the ink jet recording device 10. Further, in step S2, the image processing unit 64 performs the plate separation processing, the halftone processing, or the like on the acquired image data to generate dot data of the color ink and the white ink.

In step S11 (an example of the dividing step), the image division unit 70 divides the image into a plurality of regions. Here, the image is divided into N regions.

In step S12, the ink amount calculation unit 72 calculates the total ink amount which is the sum of the applied amount of the color ink and the applied amount of the white ink in one region among the N regions divided in step S11, based on the result of the plate separation processing by the image processing unit 64.

In step S13, determination is made as to whether or not the total ink amount calculated by the ink amount calculation unit 72 in step S12 exceeds a threshold value, which is set in advance. In a case in which the total ink amount exceeds the threshold value, the process proceeds to step S14, and in a case in which the total ink amount does not exceed the threshold value, the process proceeds to step S15.

In step S14, the treatment liquid adding control unit 74 decides the print region of the impermeable medium 12, which corresponds to the selected region, as the region to which the second treatment liquid is added. Further, in step S15, the treatment liquid adding control unit 74 decides the print region of the impermeable medium 12, which corresponds to the selected region, as the region to which the second treatment liquid is not added.

In following step S16, the ink amount calculation unit 72 determines whether or not the total ink amount is calculated for all the regions of the N regions divided in step S11. In a case in which there is a region for which the total ink amount is not calculated, the process returns to step S12, and the same process is performed. In a case in which the total ink amount is calculated for all the regions, the process proceeds to step S4.

In step S4, the treatment liquid adding control unit 74 adds the first treatment liquid to the printed surface of the impermeable medium 12 by the first treatment liquid adding unit 30. Further, the dry control unit 76 dries the first treatment liquid, which is added to the printed surface of the impermeable medium 12, by the first treatment liquid drying unit 32.

In step S5, the ink application control unit 66 prints the color image based on the dot data on the printed surface of the impermeable medium 12 by the ink jet heads 36K, 36C, 36M, and 36Y. Further, the dry control unit 76 dries the color ink applied to the printed surface of the impermeable medium 12 by the color ink drying unit 38.

In step S17, the treatment liquid adding control unit 74 adds the second treatment liquid by the second treatment liquid adding unit 40 only to the print region decided by the treatment liquid adding control unit 74 in step S14 as the region to which the second treatment liquid is added, among the printed surfaces of the impermeable medium 12. Further, the dry control unit 76 dries the second treatment liquid on the printed surface of the impermeable medium 12 by the second treatment liquid drying unit 44. In a case in which all the print regions are decided to be regions in which the second treatment liquid is not added, the dry control unit 76 stops the heater or the like (not shown) of the second treatment liquid drying unit 44.

In step S7, the ink application control unit 66 prints the background image based on the dot data on the printed surface of the impermeable medium 12 by the ink jet head 48W. Further, the dry control unit 76 dries the white ink on the printed surface of the impermeable medium 12 by the white ink drying unit 50, and the process of this flowchart ends.

According to the present embodiment, the second treatment liquid is added only to the print region in which the total ink amount exceeds the threshold value, so that the color ink and the white ink can be appropriately aggregated in each print region. Therefore, it is possible to obtain a back printed article with a high image quality.

The white ink applying unit 46 applies the white ink to the impermeable medium 12 by the ink jet method, and thus it is possible to appropriately add the second treatment liquid only to the print region in which the total ink amount exceeds the threshold value.

<Decision of Threshold Value>

In a case in which the treatment liquid is added only before printing the color ink, in a case in which the total ink amount, which is the sum of the applied amount of the color ink and the applied amount of the white ink, is large, bleed-through of ink occurs on the contacted object that comes into contact with the printed surface after printing, for example, the back surface of the impermeable medium 12 after being wound on the winding roll 16. Here, the relationship between the total ink amount of and bleed-through is evaluated.

As the evaluation condition, the recording resolution of the ink jet heads 36K, 36C, 36M, 36Y, and 48W was 1200 dot per inch (dpi), and the tension per unit cross-sectional area in a case of winding the impermeable medium 12 was 49 N/m², and the winding diameter of the winding roll 16 was 50 mm. Further, the drying condition was a condition in which a count value, which is an index of the surface water content before winding, is 92 to 98 in the region of the impermeable medium 12 to which the white ink is applied without applying the color ink. The count value was measured by using the count mode of Paper Moisture Tester HK-300-2 manufactured by Kett Electric Laboratory.

Under this condition, the bleed-through property was evaluated in the cases in which the total ink amount applied per pixel was 4.0 pl, 4.1 pl, 4.2 pl, 4.3 pl, 4.4 pl, and 4.5 pl, respectively. The results of evaluation are shown in Table 1. The determination of the bleed-through was made based on whether or not it was possible to visually confirm that the ink adhered to the back surface of the impermeable medium 12, a case in which the ink did not adhered to the back surface was determined as A, and a case in which the ink adhered was determined as B.

TABLE 1

| Ink amount [pl/pixel] | Determination |
|---|---|
| 4.0 | A |
| 4.1 | A |
| 4.2 | A |
| 4.3 | A |
| 4.4 | B |
| 4.5 | B |

As shown in Table 1, no bleed-through occurred in a case in which the total ink amount per pixel was 4.3 pl or less. Further, in a case in which the total ink amount per pixel was 4.4 pl or more, the bleed-through occurred. From the results, it was found that the second treatment liquid need only be added in a case in which the total ink amount per pixel is 4.4 pl or more.

<Pretreatment Liquid for Impermeable Medium>

The first treatment liquid and the second treatment liquid according to the present disclosure are pretreatment liquids for impermeable medium (hereinafter, also simply referred to as “pretreatment liquid”). The pretreatment liquid contains water, a resin, and an organic acid, and has the ratio of the content of the resin to the content of the organic acid is more than 0 and less than 4 on a mass basis, in which the organic acid is a compound represented by General Formula 1 below.

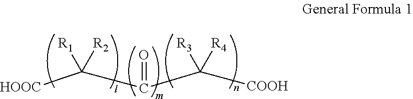

In General Formula 1, l is 1 or more, m is 0 or 1, n is 1 or more, and l+m+n is 2 or more. R1 to R4 each independently represent a hydrogen atom, a hydroxyl group, a carboxy group, an amino group, or an alkyl group which has 1 to 4 carbon atoms.

By containing the organic acid as the aggregating agent in the pretreatment liquid, the definition of the image of the obtained image recording article can be improved.

The pretreatment liquid according to the present disclosure contains water, a resin, and an organic acid, and has the ratio of the content of the resin to the content of the organic acid is more than 0 and less than 4 on a mass basis, in which a structure of the organic acid is specified by General Formula 1 above. Therefore, the affinity between the resin and the organic acid can be improved, and the transfer of the pretreatment liquid can be suppressed. Further, General Formula 1 above has at least two carboxy groups, and the ink aggregation rate is excellent, so that the image quality can be further improved.

[Organic Acid]

The organic acid according to the present disclosure is a compound represented by General Formula 1 below.

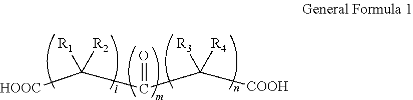

In General Formula 1, l is 1 or more, m is 0 or 1, n is 1 or more, and l+m+n is 2 or more. R1 to R4 each independently represent a hydrogen atom, a hydroxyl group (OH), a carboxy group (COOH), an amino group (NH2), or an alkyl group which has 1 to 4 carbon atoms.

Examples of the alkyl group which has 1 to 4 carbon atoms in R1 to R4 include a methyl group, an ethyl group, a propyl group, and a butyl group.

R1 to R4 described above are each independently preferably a hydrogen atom or a carboxy group, and more preferably a hydrogen atom, from the viewpoint of ink aggregating property.

It is preferable that l and n be 1 to 3, and is preferable that m be 0. It is preferable that l+m+n be 3 to 8. In a case in which l+m+n is 3 or more, the organic acid can be made more hydrophobic and the transfer suppressing property becomes better. In a case in which l+m+n is 8 or less, the organic acid does not become too hydrophobic, and the good storage stability of the pretreatment liquid can be maintained.

From the same viewpoint as above, l+m+n is more preferably 3 to 5. Further, m is preferably 0, and in a case in which m is 0, l+n is preferably 3 to 5.

As General Formula 1, it is preferable that m be 0, and R1 to R4 be hydrogen atoms.

It is preferable that at least a part of the carboxy group in General Formula 1 be dissociated in the pretreatment liquid.

Examples of the organic acid that can be used in the present disclosure include a succinic acid, a methyl succinic acid, a dimethyl succinic acid, an oxalacetic acid, a malic acid, a tartaric acid, a glutaric acid, a citric acid, a 1,2,3-propanetricarboxylic acid, a 1,3-acetonedicarboxylic acid, a methylglutaric acid, a dimethylglutaric acid, a 2-oxoglutaric acid, an adipic acid, a butane-1,2,3,4-tetracarboxylic acid, a pimelic acid, a 1,3,5-pentanetricarboxylic acid, and a 4-oxooctanedioic acid.

Among these, from the viewpoints of the image quality, the transfer suppressing property, and the storage stability of the pretreatment liquid, a glutaric acid, a pimelic acid, a propanetricarboxylic acid, a 1,2,3-propanetricarboxylic acid, and a 1,3-acetonedicarboxylic acid are preferable, a glutaric acid, a pimelic acid, and a propanetricarboxylic acid are more preferable, a glutaric acid and a pimelic acid are further preferable, and a glutaric acid is particularly preferable. These compounds may be used alone or may be used in combination of two or more.

The organic acid contained in the pretreatment liquid preferably has a high solubility in water and a valence of 2 or more, and more preferably, it is a divalent or trivalent organic acid which has a high buffering capacity in a pH region lower than pKa of the functional group (for example, a carboxy group) that disperses and stabilizes particles in the ink.

It is preferable that the pKa of the organic acid be 2.5 to 6.0. In a case in which the pKa of the organic acid is 2.5 or more, the good storage stability of the pretreatment liquid can be maintained and the transfer suppressing property can be improved. Further, in a case in which the pKa of the organic acid is 6.0 or less, the aggregating property of the pigment contained in the ink is excellent, and the image quality can be further improved.

From the viewpoints above, the pKa of the organic acid is more preferably 3.5 or more, and further preferably 4.0 or more.

In the present disclosure, the pKa is a value calculated from the molecular structure by using a software or known values. For example, it can be calculated as a calculated value by using Marvin Sketch (manufactured by ChemAxon Ltd). In a case in which the calculation is not possible by using Marvin Sketch, the calculation can be made by assigning the value of the partial structure by using the value described in “pKa Data Compiled by R. Williams”.

The content of the organic acid is not particularly limited, but from the viewpoint of the aggregation rate of the ink, it is preferably 1% by mass to 20% by mass based on the total mass of the pretreatment liquid. The content of the organic acid is more preferably 1.5% by mass to 10% by mass and further preferably 2% by mass to 5% by mass, based on the total mass of the pretreatment liquid.

[Resin]

The pretreatment liquid according to the present disclosure contains a resin. As a result, the adhesiveness between a layer formed by adding the pretreatment liquid and the impermeable medium can be improved.

The resin according to the present disclosure may be either a water-soluble resin or a water-insoluble resin, and is preferably a water-insoluble resin. Further, the resin according to the present disclosure is preferably a particle.

In the present specification, “water-insoluble” refers to a property in which a dissolved amount in 100 g of water at 25° C. is less than 1.0 g (preferably less than 0.5 g). Further, “water-soluble” refers to a property of 5 g or more (preferably 10 g or more) of the dissolved amount in 100 g of water at 25° C. The resin may contain only one kind of a resin, or may contain a plurality of resins.

(Glass Transition Temperature)

A glass transition temperature (Tg) of the resin used in the present disclosure is preferably 30° C. or higher, and more preferably 40° C. to 60° C. Therefore, the hardness of the film due to the resin is improved, and the transfer of components (for example, an organic acid) contained in the pretreatment liquid can be suppressed.

In the present disclosure, in a case in which a plurality of different types of resins are contained in the pretreatment liquid, a value obtained by the FOX equation described below is referred to as the glass transition temperature of the resin.

In the present disclosure, it is possible to measure the glass transition temperature of the resin by using differential scanning calorimetry (DSC). The specific measurement method is performed according to the method described in JIS K 7121 (1987) or JIS K 6240 (2011). As the glass transition temperature in the present specification, an extrapolation glass transition start temperature (hereinafter, may be referred to as Tig) is used.

The measurement method of the glass transition temperature will be described more specifically. In a case in which the glass transition temperature is obtained, after maintaining the device at a temperature about 50° C. lower than the expected Tg of the resin until the device stabilizes, heating is performed at the heating rate of 20° C./min to the temperature of about 30° C. higher than the temperature at which the glass transition is completed to create a differential thermal analysis (DTA) curve or DSC curve.

The extrapolation glass transition start temperature (Tig), that is, the glass transition temperature Tg in the present specification is obtained as a temperature of the intersection of a straight line which is obtained by extending the baseline on the low temperature side of the DTA curve or DSC curve to the high temperature side, and the tangent line drawn at the point in which the gradient of the curve of the stepwise change portion of the glass transition is maximized.

In the present disclosure, in a case in which a plurality of different types of resins are contained in the pretreatment liquid, the Tg of the resin is obtained by the following method.

In a case in which the Tg of a first resin is Tg1 (K), a mass fraction of the first resin based on the total mass of the resin components in the resin is W1, the Tg of a second resin is Tg2 (K), and a mass fraction of the second resin based on the total mass of the resin components in the resin is W2, Tg0 (K) of the resin can be estimated according to the FOX equation described below.

1/Tg0=(W1/Tg1)+(W2/Tg2) FOX equation:

Further, in a case in which the resin includes three types of resins, or three types of included resins which have different resin types are contained in the pretreatment liquid, in a case in which the Tg of the n-th resin is Tgn (K), and the mass fraction of the n-th resin based on the total mass of the resin components in the resin is Wn, the Tg of the resin can be estimated according to the following equation in the same manner as above.

1/Tg0=(W1/Tg1)+(W2/Tg2)+(W3/Tg3)+(Wn/Tgn) FOX equation:

(Water Contact Angle)

A water contact angle of the resin used in the present disclosure is preferably 20° or more. As a result, the resin can be specified as a hydrophobic resin, so that it is possible to further improve the affinity with the organic acid and to further suppress the transfer of the pretreatment liquid. From the above viewpoint, the water contact angle of the resin is more preferably 25° to 45°.

The water contact angle of the resin is measured by the method described below.

A water contact angle measuring solution (in a case in which the resin is water-insoluble, a water contact angle measuring dispersion liquid) which has the following composition is prepared by using the resin to be measured. Then, the prepared water contact angle measuring solution is applied to polyethylene terephthalate (PET, FE2001, thickness of 12 μm, manufactured by FUTAMURA CHEMICAL CO., LTD.) such that the liquid application amount is 1.7 μm, and dried at 80° C. for 30 seconds to manufacture a film. The contact angle of the manufactured film is measured after 1 minute by using a contact angle meter Dropmaster DM700 (manufactured by Kyowa Interface Science Co., Ltd.) according to the method described in JIS R 3257. The amount of liquid droplets is the 2 μL.

—Water Contact Angle Measuring Solution (Water Contact Angle Measuring Dispersion Liquid)—
resin: 15% by mass as solid content
surfactant: TAYCAPOWER BN2070M, 0.7% by mass
propylene glycol: 10% by mass
water: remainder

Further, in the present disclosure, the solid content means the remainder of each component excluding solvents such as water and an organic solvent.

In a case in which a plurality of different types of resins are contained in the pretreatment liquid, the content of each resin in the water contact angle measuring solution is decided depending on the content mass fraction of each resin in the pretreatment liquid such that the total mass of the resin is 15% by mass as the solid content.

For example, in a case in which 20% by mass of the first resin and 80% by mass of the second resin are contained in the total mass of the resin in the pretreatment liquid, the measurement is made by containing 3% by mass of the first resin as the solid content and 12% by mass of the second resin as the solid content in the water contact angle measuring solution.

(Alicyclic Structure or Aromatic Ring Structure)

It is preferable that the resin used in the present disclosure have an alicyclic structure or an aromatic ring structure in the structure, and more preferable that the resin have an aromatic ring structure, from the viewpoint of improving the glass transition temperature and the water contact angle.

The alicyclic structure is preferably an alicyclic hydrocarbon structure which has 5 to 10 carbon atoms, and more preferably, a cyclohexane ring structure, a dicyclopentanyl ring structure, a dicyclopentenyl ring structure, or an adamantane ring structure.

The aromatic ring structure is preferably a naphthalene ring or a benzene ring, and more preferably a benzene ring.

The amount of the alicyclic structure or the aromatic ring structure is not particularly limited, and it is preferably the amount in which the glass transition temperature and the water contact angle of the resin are within the above range. Above all, for example, it is preferably 0.01 mol to 1.5 mol per 100 g of the resin, and more preferably 0.1 mol to 1 mol.

(Ionic Group)

The resin used in the present disclosure preferably has an ionic group in the structure, from the viewpoint that it is preferable that the resin particle have water dispersibility described below.

Examples of the ionic group include a carboxy group, a sulfonic acid group, a phosphoric acid group, a boric acid group, an amino group, a quaternary ammonium group, or salts thereof. Among these, a carboxy group, a sulfonic acid group, a phosphoric acid group, or salts thereof is preferable, a carboxy group, a sulfonic acid group, or salts thereof is more preferable, and a sulfonic acid group or a salt thereof is further preferable.

The ionic group may be an anionic group or a cationic group, but from the viewpoints of ease of introduction, the image quality, the adhesiveness, and the transfer suppressing property, an anionic group is preferable. The anionic group is preferably a sulfonic acid group or a salt thereof.

The amount of the ionic group is not particularly limited, and the amount can be preferably used as long as the resin is a resin particle which has the water dispersibility, for example, it is preferably 0.001 mol to 1.0 mol per 100 g of the resin, and more preferably 0.01 mol to 0.5 mol.

(Content)

The pretreatment liquid used in the present disclosure preferably contains 1% by mass to 25% by mass of the resin, more preferably contains 2% by mass to 20% by mass of the resin, and further preferably contains 3% by mass to 15% by mass of the resin, based on the total mass of the pretreatment liquid.

In the present disclosure, a ratio of the content of the resin to the content of the organic acid is more than 0 and less than 4 on a mass basis. In a case in which the ratio of the content of the resin to the content of the organic acid is more than 0 on a mass basis, the content of the organic acid to the content of the resin does not become excessive, and the transfer suppressing property and the storage stability of the pretreatment liquid can be improved.

In a case in which the ratio of the content of the resin to the content of the organic acid is less than 4 on a mass basis, the content of the organic acid to the content of the resin does not become too small, and the good image quality can be maintained. From the viewpoints above, it is preferable that the ratio of the content of the resin to the content of the organic acid be more than 0 and less than 2 on a mass basis.

(Resin Particle)

As the resin, either a water-soluble resin or resin particle can be used, but the resin particle is preferable. Further, the resin particles which have the water dispersibility are more preferable. In the present disclosure, the water dispersibility means that no precipitation is confirmed even in a case in which stirring is performed in water at 20° C. and then left at 20° C. for 60 minutes.

The resin contained in the resin particle used in the present disclosure is not particularly limited, but examples thereof include a polyurethane resin, a polyamide resin, a polyurea resin, a polycarbonate resin, a polyolefin resin, a polystyrene resin, a polyester resin, an acrylic resin, and the like, it is preferably a polyester resin or an acrylic resin, and more preferably a polyester resin. The resin may be a composite particle of a plurality of resins selected from the resins described above. Among these, the composite particle of a polyester resin and an acrylic resin is preferable.

—Volume Average Particle Diameter—

The volume average particle diameter of the resin particles is preferably 1 nm to 300 nm, more preferably 3 nm to 200 nm, and further preferably 5 nm to 150 nm.

In the present disclosure, the volume average particle diameter is measured by a laser diffraction/scattering type particle diameter distribution meter. Examples of the measuring device include a particle diameter distribution measuring device “Microtrac MT-3300II” (manufactured by Nikkiso Co., Ltd).

—Weight-Average Molecular Weight—

A weight-average molecular weight (Mw) of the resin particles is preferably 1,000 to 300,000, more preferably 2,000 to 200,000, and further preferably 5,000 to 100,000.

In the present disclosure, the weight-average molecular weight is measured by Gel Permeation Chromatography (GPC) unless otherwise noted. As the GPC, HLC-8020 GPC (manufactured by Tosoh Corporation) is used, and three TSKgel (registered trademark) Super Multipore HZ-H (manufactured by Tosoh Corporation, 4.6 mm ID×15 cm) are used as a column, and THF (tetrahydrofuran) is used as the eluent. As the condition, a sample concentration is 0.45% by mass, a flow rate is 0.35 ml/min, a sample injection amount is 10 μl, a measurement temperature is 40° C., and a refractive index (RI) detector is used. Further, the calibration curve is produced from 8 samples of “standard sample TSK standard polystyrene” manufactured by Tosoh Corporation: “F-40”, “F-20”, “F-4”, “F-1”, “A-5000”, “A-2500”, “A-1000”, and “n-propylbenzene”.

### Specific Example

Specific examples of the resin particles include Pesresin A124GP, Pesresin A645GH, Pesresin A615GE (all manufactured by Takamatsu Oil & Fat Co., Ltd.), Eastek 1100, Eastek 1200 (all manufactured by Eastman Chemical Company), PLAS COAT RZ570, PLAS COAT Z687, PLAS COAT Z565, PLAS COAT Z690 (all manufactured by GOO CHEMICAL CO., LTD.), Veronal (registered trademark) MD1200 (manufactured by Toyobo Co., Ltd.), EM57DOC (manufactured by Daicel Chem Ltd.), Superflex 300 (manufactured by DKS Co., Ltd.), and the like.

(Water-Soluble Resin)

The resin may be the water-soluble resin. The water-soluble resin is not particularly limited, and a known water-soluble resin such as polyvinyl alcohol, polyacrylamide, polyvinylpyrrolidone, polyethylene glycol, polyacrylic acid, and polyester can be used. Further, a synthetic product can be used as the water-soluble resin.

Further, as the water-soluble resin, the water-soluble resin disclosed in paragraphs 0026 to 0080 of JP2013-001854A is also suitable.

The weight-average molecular weight of the water-soluble resin is not particularly limited, but it can be, for example, 10,000 to 100,000, is preferably 20,000 to 80,000, and more preferably 30,000 to 80,000. The weight-average molecular weight of the water-soluble resin can be measured by the method described above.

[Water]

The pretreatment liquid contains water. As the water, for example, ion exchange water, distilled water, and the like can be used. The content of water is preferably 50% by mass to 90% by mass, and more preferably 60% by mass to 80% by mass, based on the total mass of the pretreatment liquid.

[Water-Soluble Solvent]

It is preferable that the pretreatment liquid contain at least one of water-soluble solvents. The water-soluble solvent is not particularly limited, and known materials can be used. Examples of the water-soluble solvent include glycols such as glycerin, 1,2,6-hexanetriol, trimethylolpropane, ethylene glycol, propylene glycol, diethylene glycol, triethylene glycol, tetraethylene glycol, pentaethylene glycol, and dipropylene glycol; polyhydric alcohols such as alkanediols such as 2-buten-1,4-diol, 2-ethyl-1,3-hexanediol, 2-methyl-2,4-pentanediol, 1,2-octanediol, 1,2-hexanediol, 1,2-pentanediol, 4-methyl-1,2-pentanediol; sugars or sugar alcohols, hyaluronic acids, alkyl alcohols having 1 to 4 carbon atoms, glycol ethers, 2-pyrrolidone, N-methyl-2-pyrrolidone, which are disclosed in paragraph 0116 of JP2011-042150A; and the like.

Among these, from the viewpoint of suppressing transfer of components contained in the pretreatment liquid, polyalkylene glycol or a derivative thereof is preferable, and at least one selected from diethylene glycol monoalkyl ether, triethylene glycol monoalkyl ether, dipropylene glycol, tripropylene glycol monoalkyl ether, polyoxypropylene glyceryl ether, or polyoxyethylene polyoxypropylene glycol is more preferable.

The content of the water-soluble solvent in the pretreatment liquid is preferably 3% by mass to 20% by mass, and more preferably 5% by mass to 15% by mass based on the entire pretreatment liquid, from the viewpoint of application property, and the like.

From the viewpoint of the adhesiveness with the base material, it is preferable that the pretreatment liquid used in the present disclosure do not contain the water-soluble organic solvent having 13 or less of a solubility parameter (SP) value or contain the water-soluble organic solvent having 13 or less of the SP value, in amount of more than 0% by mass and less than 10% by mass based on the total mass of the pretreatment liquid, more preferable that the pretreatment liquid do not contain the water-soluble organic solvent having 13 or less of the SP value or contain the water-soluble organic solvent having 13 or less of the SP value, in amount of more than 0% by mass and less than 5% by mass by mass based on the total mass of the pretreatment liquid, further preferable that the pretreatment liquid do not contain the water-soluble organic solvent having 13 or less of the SP value or contain the water-soluble organic solvent having 13 or less of the SP value, in amount of more than 0% by mass and less than 2% by mass by mass based on the total mass of the pretreatment liquid, and particularly preferable that the pretreatment liquid do not contain the water-soluble organic solvent having 13 or less of the SP value.

The SP value in the present disclosure shall be calculated by the Okitsu method (“Journal of the Japan Adhesive Society” by OKITSU Toshinao, 29 (5) (1993)). Specifically, the SP value is calculated by the following equation. Note that ΔF is a value described in the literature.

SP value (δ)=ΣΔF (Molar Attraction Constants)/V (molar volume)

The unit of the SP value in the present disclosure is (cal/cm³)^{1/2}.

[ Surfactant]

The pretreatment liquid may contain at least one of surfactants. The surfactant can be used as a surface tension adjuster or an antifoaming agent. Examples of the surface tension adjuster or the antifoaming agent include a nonionic surfactant, a cationic surfactant, an anionic surfactant, a betaine surfactant, and the like. Among these, a nonionic surfactant or an anionic surfactant is preferable from the viewpoint of the aggregation rate of the ink.

Examples of the surfactant include the compounds described as the surfactant in pages 37 to 38 of JP1984-157636A (JP-S-59-157636A) and Research Disclosure No. 308119 (1989). Also, examples thereof include the fluorine (alkyl fluoride-based) surfactants or the silicone-based surfactants disclosed in JP2003-322926A, JP2004-325707A, and JP2004-309806A.

The content of the surfactant in the pretreatment liquid is not particularly limited, but it is preferably the content at which the surface tension of the pretreatment liquid is 50 mN/m or less, more preferably the content at which the surface tension of the pretreatment liquid is 20 mN/m to 50 mN/m, and further preferably the content at which the surface tension of the pretreatment liquid is 30 mN/m to 45 mN/m.

[Other Additives]

The pretreatment liquid may contain components other than the above, if necessary. Examples of other components that may be contained in the pretreatment liquid include known additives such as a solid wetting agent, a colloidal silica, an inorganic salt, an antifading agent, an emulsion stabilizer, a penetration enhancer, an ultraviolet absorbing agent, a preservative, an antibacterial agent, a pH adjusting agent, a viscosity adjuster, a rust inhibitor, a chelating agent, and the like.

[Physical Property of Pretreatment Liquid]

From the viewpoint of the aggregation rate of the ink, the pretreatment liquid preferably has a pH of 2 to 4 at 25° C. In a case in which the pH of the pretreatment liquid is 2 or more, the roughness of the impermeable medium is further reduced, and the adhesiveness of the image area is further improved. In a case in which the pH of the pretreatment liquid is 4 or less, the aggregation rate is further improved, the coalescence of dots (ink dots) due to the ink on the impermeable medium is further suppressed, and the roughness of the image is further reduced. The pH (25° C.) of the pretreatment liquid is more preferably 2.5 to 3.5.

In the present disclosure, the pH is a value measured at 25° C. by using a pH meter (model number: HM-31, manufactured by DKK-TOA CORPORATION).

From the viewpoint of the aggregation rate of the ink, the viscosity of the pretreatment liquid is preferably in the range of 0.5 mPa·s to 10 mPa·s, and more preferably in the range of 1 mPa·s to 5 mPa·s. The viscosity is measured under the condition of 25° C. by using VISCOMETER TV-22 (manufactured by TOKI SANGYO CO., LTD).

The surface tension of the pretreatment liquid at 25° C. is preferably 60 mN/m or less, more preferably 20 mN/m to 50 mN/m, and further preferably 30 mN/m to 45 mN/m. In a case in which the surface tension of the pretreatment liquid is within the range, the adhesiveness between the impermeable medium and the pretreatment liquid is improved. The surface tension of the pretreatment liquid is measured by the plate method by using Automatic Surface Tensiometer CBVP-Z (manufactured by Kyowa Interface Science Co., Ltd).

<Impermeable Medium>

The pretreatment liquid according to the present disclosure is used by being added to the impermeable medium. In the present disclosure, the impermeable medium refers to a medium in which the absorption amount of water at a contact time of 900 milliseconds (ms) by the Bristow method (also referred to as “900 ms water absorption amount”) is less than 4 ml/m². The impermeable medium is a medium that does not contain a paper, and is preferably a resin base material.

[Resin Base Material]

The resin base material used as the impermeable medium is not particularly limited, and examples thereof include a base material made of a thermoplastic resin. Examples of the resin base material include a base material obtained by forming the thermoplastic resin into a sheet shape.

It is preferable that the resin base material contain polypropylene, polyethylene terephthalate, nylon, polyethylene, polyimide, or polyvinyl chloride.

The resin base material may be a transparent resin base material or a colored resin base material, or at least a part thereof may be subjected to metal vapor deposition treatment.

The shape of the resin base material according to the present disclosure is not particularly limited, but it is preferably a sheet-shaped resin base material, and from the viewpoint of productivity of the image recording article, and more preferably the resin base material that can be formed by the roll by winding the sheet-shaped resin base material. The sheet-shaped resin base material is not limited to a long continuous base material, and may be a sheet type base material.

Further, the pretreatment liquid according to the present disclosure can be particularly suitably used for image recording on the resin base material for flexible packaging from the viewpoint of suppressing the transfer of components contained in the pretreatment liquid.

The resin base material may be subjected to surface treatment. Examples of the surface treatment include corona treatment, plasma treatment, frame treatment, heat treatment, abrasion treatment, light irradiation treatment (ultra violet (UV) treatment), flame treatment, and the like, but are not limited to this.

For example, in a case in which the surface of the resin base material is subjected to the corona treatment in advance before the ink is applied to print the image, the surface energy of the resin base material increases, and the surface of the resin base material becomes wet and ink adhesion to the resin base material is promoted. The corona treatment can be performed by using, for example, a corona master (manufactured by Shinko Electric & Instrumentation Co., Ltd., PS-10S), or the like. The conditions for the corona treatment need only be appropriately selected depending on the type of resin base material, the ink composition, and the like. For example, the treatment conditions below may be used.
treatment voltage: 10 to 15.6 kV
treatment speed: 30 to 100 mm/s

The water contact angle of the surface to which the pretreatment liquid of the resin base material is added is preferably 10° to 150°, and more preferably 30° to 100°.

The surface free energy of the surface to which the pretreatment liquid of the resin base material is added is preferably at 10 mNm⁻¹ or more, and more preferably 30 mNm⁻¹ or more.

<Ink Composition>

The ink composition used in the present disclosure will be described below. The ink composition used in the present disclosure preferably contains the coloring agent and water, and it is preferably an aqueous ink composition. In the present disclosure, the aqueous ink composition refers to an ink composition, which contains 50% by mass or more of water based on the total mass of the ink.

Further, in the ink composition according to the present disclosure, the content of the organic solvent is preferably less than 50% by mass, and more preferably 40% by mass or less, based on the total mass of the ink composition.

Further, it is preferable that the ink composition according to the present disclosure do not contain a polymerizable compound, or contain the polymerizable compound in amount of more than 0% by mass and 10% by mass or less, and more preferable that the ink composition do not contain a polymerizable compound.

Examples of the polymerizable compound include a cationic polymerizable compound and a radical polymerizable compound.

[Coloring Agent]

The coloring agent is not particularly limited, and a coloring agent known in the field of ink for ink jet can be used, but an organic pigment or an inorganic pigment is preferable.

Examples of the organic pigment include an azo pigment, a polycyclic pigment, a chelate dye, a nitro pigment, a nitroso pigment, an aniline black, and the like. Among these, an azo pigment, a polycyclic pigment, and the like are more preferable.

Examples of the inorganic pigment include titanium oxide, iron oxide, calcium carbonate, barium sulfate, aluminum hydroxide, barium yellow, cadmium red, chrome yellow, and carbon black. Among these, carbon black is particularly preferable.

As the coloring agent, the coloring agent disclosed in paragraphs 0096 to 0100 of JP2009-241586A is preferable.

The content of the coloring agent is preferably 1% by mass to 25% by mass, more preferably 2% by mass to 20% by mass, further preferably 5% by mass to 20% by mass, and particularly preferably 5% by mass to 15% by mass, based on the total mass of the ink composition.

[Water]

It is preferable that the ink composition contain water. The content of water is preferably 50% by mass to 90% by mass, and more preferably 60% by mass to 80% by mass, based on the total mass of the ink composition.

[Dispersing Agent]

The ink composition used in the present disclosure may contain a dispersing agent for dispersing the coloring agent. The dispersing agent may be either a polymer dispersing agent or a low molecular weight surfactant type dispersing agent. Further, the polymer dispersing agent may be either a water-soluble dispersing agent or a water-insoluble dispersing agent.

As the dispersing agent, for example, the dispersing agent disclosed in paragraphs 0080 to 0096 of JP2016-145312A is preferable.

The mixing mass ratio (p:s) of the coloring agent (p) and the dispersing agent (s) is preferably in the range of 1:0.06 to 1:3, more preferably in the range of 1:0.125 to 1:2, and further preferably in the range of 1:0.125 to 1:1.5.

[Resin Particle]

The ink composition according to the present disclosure may contain at least one of resin particles. By containing the resin particles, it is possible to further improve the fixing property and scratch resistance of the ink composition to the impermeable medium. Further, the resin particles have a function of fixing the ink composition, that is, the image by aggregating or dispersing and destabilizing the resin particles to thicken the ink composition in a case of being contact with the organic acid. It is preferable that such resin particles be dispersed in water and an organic solvent containing water.

As the resin particles, for example, the resin particles disclosed in paragraphs 0062 to 0076 of JP2016-188345A are preferable.

From the viewpoint of scratch resistance of the obtained image, the Tg of the resin particles contained in the ink composition is preferably higher than the Tg of the resin described above.

[Water-soluble Organic Solvent]

It is preferable that the ink composition used in the present disclosure contain at least one of water-soluble organic solvents. The water-soluble organic solvent can obtain an anti-drying effect or a wetting effect. For anti-drying, the ink adheres to the ink jet port of the jetting nozzle and is dried to form an aggregate, which is used as an anti-drying agent to prevent clogging, and for anti-drying or wetting, a water-soluble organic solvent which has a vapor pressure lower than that of water is preferable.

The boiling point of the water-soluble organic solvent at 1 atmospheric pressure (1013.25 hPa) is preferably 80° C. to 300° C., and more preferably 120° C. to 250° C.

As the anti-drying agent, a water-soluble organic solvent which has a vapor pressure lower than that of water is preferable. Specific examples of such a water-soluble organic solvent include polyhydric alcohols represented by ethylene glycol, propylene glycol, diethylene glycol, polyethylene glycol, thiodiglycol, dithiodiglycol, 2-methyl-1,3-propanediol, 1,2,6-hexanetriol, acetylene glycol derivative, glycerin, trimethylolpropane, and the like.

Among these, as the anti-drying agent, polyhydric alcohols such as glycerin and diethylene glycol are preferable.

The anti-drying agent may be used alone, or in combination of two or more. It is preferable that the content of the anti-drying agent be in the range of 10 to 50% by mass in the ink composition.

The water-soluble organic solvent is used for adjusting the viscosity in addition to the above. Specific examples of the water-soluble organic solvent that can be used for adjusting the viscosity include alcohols (for example, methanol, ethanol, propanol, isopropanol, butanol, isobutanol, sec-butanol, t-butanol, pentanol, hexanol, cyclohexanol, and benzyl alcohol), polyhydric alcohols (for example, ethylene glycol, diethylene glycol, triethylene glycol, polyethylene glycol, propylene glycol, dipropylene glycol, polypropylene glycol, butylene glycol, hexanediol, pentanediol, glycerin, hexanetriol, and thiodiglycol), glycol derivatives (for example, ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether, and ethylene glycol monophenyl ether), amines (for example, ethanolamine, diethanolamine, triethanolamine, N-methyldiethanolamine, N-ethyldiethanolamine, morpholine, N-ethylmorpholine, ethylenediamine, diethylenetriamine, triethylenetetramine, polyethyleneimine, and tetramethylpropylenediamine), and other polar solvents (for example, formamide, N,N-dimethylformamide, N,N-dimethylacetamide, dimethyl sulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile, and acetone). In this case, the water-soluble organic solvent may also be used alone or in combination of two or more.

[Other Additives]

The ink composition used in the present disclosure can be configured by using other additives in addition to the components described above. Examples of other additives include known additives such as an anti-drying agent (wetting agent), an antifading agent, an emulsion stabilizer, a penetration enhancer, an ultraviolet absorbing agent, a preservative, an antibacterial agent, a pH adjusting agent, a surface tension adjuster, an antifoaming agent, a viscosity adjuster, a dispersing agent, a dispersion stabilizer, a rust inhibitor, a chelating agent, and the like.

<Others>

The manufacturing method of the printed article described above can be configured as a program that realizes each step on a computer, and a non-temporary storage medium such as a compact disk-read only memory (CD-ROM) that stores this program can be configured.

In the embodiments described so far, for example, the hardware structure of the processing unit that executes various processing of the control unit 60 is the following various processors. The various processors include the CPU, which is a general-purpose processor that executes software (program) and functions as various processing units, a graphics processing unit (GPU) which is specialized for image processing, a programmable logic device (PLD) that is a processor whose circuit configuration can be changed after manufacture such as a field programmable gate array (FPGA), and a dedicated electric circuit that is a processor which has a circuit configuration that is designed for exclusive use in order to execute specific processing such as an application specific integrated circuit (ASIC).

One processing unit may be configured by one of these various processors, or may be configured by two or more processors of the same type or different types (for example, a plurality of FPGAs, a combination of a CPU and a FPGA, or a combination of a CPU and a GPU). Alternatively, a plurality of processing units may be configured by one processor. As an example of configuring a plurality of processing units with one processor, first, as represented by a computer such as a server or a client, there is a form in which one processor is configured by a combination of one or more CPUs and software, and the processor functions as a plurality of processing units. Second, as represented by a system on chip (SoC) or the like, there is a form in which a processor is used in which the functions of the entire system which includes a plurality of processing units are realized by a single integrated circuit (IC) chip. As described above, the various processing units are configured by one or more various processors as a hardware structure.

Furthermore, the hardware structures of these various processors are, more specifically, an electric circuit (circuitry) in which circuit elements such as semiconductor elements are combined.

The technical scope of the present invention is not limited to the scope of the embodiments described above. The configurations and the like in the embodiments can be appropriately combined between the respective embodiments without departing from the spirit of the present invention.

### EXPLANATION OF REFERENCES

10: ink jet recording device
12: impermeable medium
14: sending roll
16: winding roll
18: transporting unit
20: guide roller
22: guide roller
24: guide roller
26: guide roller
28: guide roller
30: first treatment liquid adding unit
32: first treatment liquid drying unit
34: color ink applying unit
36C: ink jet head
36K: ink jet head
36M: ink jet head
36Y: ink jet head
38: color ink drying unit
40: second treatment liquid adding unit
42: second treatment liquid jetting head
44: second treatment liquid drying unit
46: white ink applying unit
48W: ink jet head
50: white ink drying unit
60: control unit
62: image acquiring unit
64: image processing unit
66: ink application control unit
68: transport control unit
70: image division unit
72: ink amount calculation unit
74: treatment liquid adding control unit
76: dry control unit
S1 to S17: steps of manufacturing method of printed article

What is claimed is:

1. A manufacturing method of a printed article, the method comprising:
a first treatment liquid adding step of adding a first treatment liquid which contains an aggregating agent that aggregates a color ink and a white ink to a transparent impermeable medium which is a printed article;
a color ink applying step of applying the color ink to the impermeable medium to which the first treatment liquid is added by an ink jet method to print an image;
a white ink applying step of applying the white ink to the impermeable medium to which the color ink is applied by the ink jet method;
a calculating step of calculating a total amount of an applied amount of the color ink and an applied amount of the white ink; and
a second treatment liquid adding step of, in a case in which the total amount exceeds a threshold value, adding a second treatment liquid which contains at least the aggregating agent that aggregates the white ink to the impermeable medium by the ink jet method after the color ink is applied and before the white ink is applied.

2. The manufacturing method of a printed article according to claim 1, further comprising an image acquiring step of acquiring image data indicating the image,
wherein in the calculating step, the total amount is calculated from the image data.

3. The manufacturing method of a printed article according to claim 2, further comprising a dividing step of dividing the image into a plurality of regions,
wherein in the calculating step, the total amount is calculated for each of the divided regions, and
in the second treatment liquid adding step, the second treatment liquid is added to a print region of the impermeable medium, which corresponds to the region in which the total amount exceeds the threshold value.

4. The manufacturing method of a printed article according to claim 1, further comprising a first drying step of drying the impermeable medium to which the color ink is applied.

5. The manufacturing method of a printed article according to claim 1, further comprising a second drying step of drying the impermeable medium to which the white ink is applied.

6. The manufacturing method of a printed article according to claim 1, wherein in the first treatment liquid adding step, the first treatment liquid is applied to the impermeable medium by using a coating roller.

7. The manufacturing method of a printed article according to claim 1, wherein the first treatment liquid and the second treatment liquid contain an acid.

8. The manufacturing method of a printed article according to claim 7, wherein an amount of the acid per unit area of the first treatment liquid which is added to the impermeable medium is equal to an amount of the acid per unit area of the second treatment liquid which is added to the impermeable medium.

9. A printing device comprising:
a first treatment liquid adding unit that adds a first treatment liquid which contains an aggregating agent that aggregates a color ink and a white ink to an impermeable medium;
a color ink applying unit that applies the color ink to the impermeable medium to which the first treatment liquid is added by an ink jet method to print an image;
a white ink applying unit that applies the white ink to the impermeable medium to which the color ink is applied by the ink jet method;
a calculating unit that calculates a total amount which is a sum of an applied amount of the color ink and an applied amount of the white ink; and
a second treatment liquid adding unit that adds, in a case in which the total amount exceeds a threshold value, a second treatment liquid which contains at least the aggregating agent that aggregates the white ink to the impermeable medium by the ink jet method after the color ink is applied and before the white ink is applied.

10. The printing device according to claim 9, further comprising a transporting unit that transports the impermeable medium to the first treatment liquid adding unit, the color ink applying unit, the second treatment liquid adding unit, and the white ink applying unit in this order.

11. The printing device according to claim 10, wherein the transporting unit draws out a long impermeable medium which is wound in a roll shape to transport the impermeable medium, and winds the printed impermeable medium in the roll shape.
